(19) United States
(12) Patent Application Publication
(10) Pub. No.: US 2020/0175631 A1
(43) Pub. Date: Jun. 4, 2020

(54) VESSEL CARGO OPERATION IDENTIFICATION

(71) Applicant: DA-Desk FZE-LLC, Dubai (AE)

(72) Inventor: Aleksandrs Tarasenko, Dubai (AE)

(73) Assignee: DA-Desk FZ-LLC, Dubai (AE)

(21) Appl. No.: 16/689,948

(22) Filed: Nov. 20, 2019

Related U.S. Application Data
(60) Provisional application No. 62/773,393, filed on Nov. 30, 2018.

(51) Int. Cl. G06Q 50/28; G06Q 10/08; H04W 4/021; H04W 4/029; G01G 19/08

(52) U.S. Cl. CPC G06Q 50/28; G06Q 10/0831; G06Q 10/0833; G01G 19/086; H04W 4/021; H04W 4/029; G06Q 10/0838

(57) ABSTRACT

A system and method for determining operating characteristics of a maritime vessel by receiving AIS information, including vessel draft information, analyzing vessel location information, including analyzing the history of vessel positions at loading and discharging stations, and comparing that information to determine loading and discharging operations. Certain embodiments provide for calculating an amount of cargo using a predetermined vessel characteristic tonnes per centimeter immersion. The system and method provide for improved vessel performance metrics and facilitate quality improvements in cargo management systems.

### PRIORITY

This application claims the benefit of co-pending U.S. provisional application No. 62/773,393 by the same inventor, filed Nov. 30, 2018, which is incorporated by reference as if fully set forth herein.

### BACKGROUND

Navigating, transporting, managing, predicting and coordinating ocean vessel traffic is an age-old problem faced by the maritime industry for centuries. The maritime Automatic Information System (AIS) provides some information to address these problems. The Automatic Identification System (AIS) is an automatic tracking system used on ships and by vessel traffic services (VTS) for identifying and locating vessels by electronically exchanging data with other nearby ships, AIS base stations, and satellites. When satellites are used to detect AIS signatures then the term Satellite-AIS (S-AIS) is often used. AIS information supplements marine radar, which continues to be the primary method of collision avoidance for water transport.

Information provided by AIS equipment, such as unique identification, position, course and speed, can be displayed on a screen or networked device. AIS is intended to assist a vessel's watchstanding officers and allow maritime authorities to track and monitor vessel movements. Conventionally, AIS integrates a standardized VHF transceiver with a positioning system such as a GPS receiver, with other electronic navigation sensors, such as a gyrocompass or rate of turn indicator. Vessels fitted with AIS transceivers can be tracked by AIS base stations located along coast lines or, when out of range of terrestrial networks, through a growing number of satellites that are fitted with special AIS receivers which are capable of de-conflicting a large number of signatures. The base stations and satellites are coupled to networks for providing the AIS information to remote users.

The International Maritime Organization's International Convention for the Safety of Life at Sea requires AIS to be fitted aboard international voyaging ships with gross tonnage (GT) of 300 or more, and all passenger ships regardless of size. Accordingly, AIS is widely used in marine transportation systems.

While AIS information is becoming widely available, there is a need to extract meaningful data from this information for efficient operation of marine transportation systems. Moreover, there is a need to couple the AIS information with other transportation and port information to efficiently schedule and price transportation requirements. Additionally, loading and unloading times may be fairly well estimated, however, there may be wide variations in port operation times depending on terminal equipment, seasonality, port, berth and terminal utilization rates, as well as port operation characteristics and other conditions in the port area that affect the operation of those ports.

In view of the foregoing, reliable quantification, estimation and scheduling are needed to maximize overall transport efficiency.

### BRIEF DESCRIPTION OF THE DRAWINGS

FIG. 1 shows a functional block diagram of a client server system.

FIG. 2 illustrates steps in a method that may be employed in certain embodiments.

### SUMMARY

Disclosed herein is a system and method for determining operating characteristics of a maritime vessel by receiving AIS information, including vessel draft information, analyzing vessel location information, including analyzing the history of vessel positions at loading and discharging stations, and comparing that information to determine loading and discharging operations. Certain embodiments provide for calculations of a vessel characteristic Tonnes Per Centimeter Immersion (TPCI) which may be associated with certain types of cargos. The system and method provide for improved vessel performance metrics and facilitate quality improvements in cargo management systems.

Vessel draft information may be near supplied in port or underway and corrective calculations may be employed to associate the changes in cargo to the type of cargo by analyzing the vessel's historic locations. These historic locations may be identified with known cargo load and discharge stations, for example fueling stations or cargo terminals, to determine the type and amount of cargo loaded or discharged.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventors contemplate using those techniques, and think they are best for the intended application. This does not exclude other techniques for the invention and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

An International Maritime Organization (IMO) number is a unique reference for ships, registered shipowners and management companies

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example, and without limitation, in cases in which a measure or value is “relatively increased” or “relatively more”, that comparison need not be with respect to any known measure or value but might be with respect to a measure or value held by that measurement or value at another place or time.

The terms “structured data” and “structured data source” generally means a coherent way to save and access information such as in a database, XML file and the like.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

The term “virtual machine” or “VM” generally refers to a self-contained operating environment that behaves as if it is a single computer even though it is part of a separate computer or may be virtualized using resources from multiple computers.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor-based device. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover, any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), AIS transmitters and receivers, laptop, notebook and tablet computing devices operating through wireless networks. These wireless devices may include a processor, memory coupled to the processor, displays, keypads, WiFi, Bluetooth, GPS and other I/O functionality. Alternatively, the entire processing system may be self-contained on a single device or effectuated remotely as a virtual machine.

### Client-Server Processing

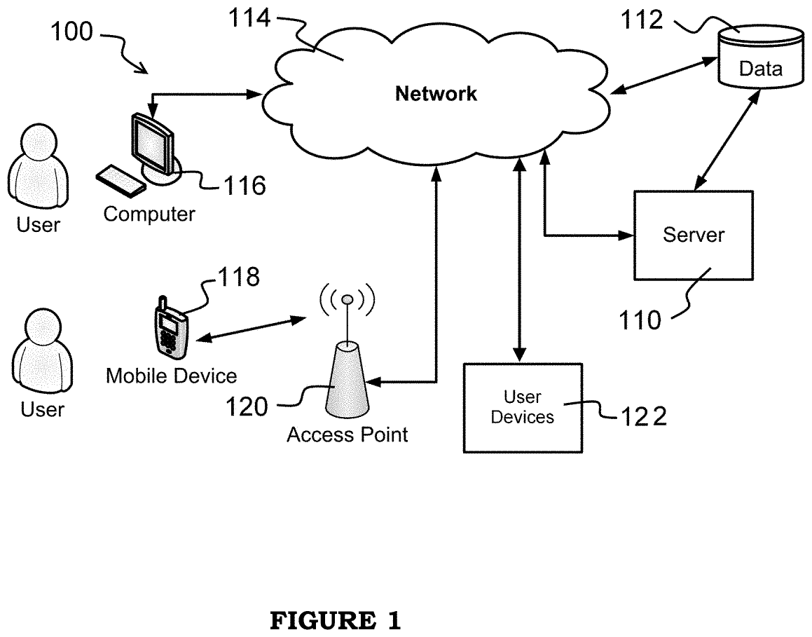

FIG. 1 shows a functional block diagram of a client server system 100 that may be employed for some embodiments according to the current disclosure. In the FIG. 1, a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively, the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

Conventionally, client-server processing operates by dividing the processing between two devices such as a server and a smart device such as a cell phone or other computing device. The workload is divided between the servers and the clients according to a predetermined specification. For example, in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine-readable instructions are conventionally known including applets and are written in a variety of languages including Java and JavaScript.

Client-server applications also provide for software-as-a-service (SaaS) applications where the server provides software to the client on an as-needed basis.

In addition to the transmission of instructions, client-server applications also include transmission of data between the client and server. Often, this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus, data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein, a display engine, a data engine, an execution engine, a user interface (UI) engine, and the like may be employed. These engines may seek and gather information about events from remote data sources.

In this disclosure, the above described systems also include radio and satellite transmission systems as well as AIS information collection devices and the associated networks employed in the aforementioned AIS systems.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

In addition, the information, including AIS messages, may be stored in a structured data store for sourcing the data when needed. This may include a series of discrete messages or data or may involve a larger aggregated message including information from multiple messages, including those messages appended as described herein. Accordingly, method steps that call for adding information, such as status, to a message, may be effectuated by adding a record to a structured data store associated with a particular ship or vessel or modifying an existing record to include additional information.

### AIS Data

An AIS transceiver sends the following data every 2 to 10 seconds depending on a vessel's speed while underway, and every 3 minutes while a vessel is at anchor:
The vessel's Maritime Mobile Service Identity (MMSI)—a unique nine-digit identification number.
Navigation status—“at anchor”, “under way using engine(s)”, “not under command”, etc.
Rate of turn—right or left, from 0 to 720 degrees per minute.
Speed over ground—0.1-knot (0.19 km/h) resolution from 0 to 102 knots (189 km/h).
Positional accuracy: Longitude—to 0.0001 minutes, Latitude—to 0.0001 minutes
Course over ground—relative to true north to 0.1°.
True heading—0 to 359 degrees (conventionally from a gyrocompass).
True bearing at own position; 0 to 359 degrees.
UTC Seconds—The seconds field of the UTC time when these data were generated. A complete timestamp is conventionally not transmitted.

In addition, the following data is broadcast every 6 minutes:
IMO ship identification number—a seven-digit number that remains unchanged upon transfer of the ship's registration to another country.
Radio call sign—international radio call sign, up to seven characters, assigned to the vessel by its country of registry.
Name of vessel—up to 20 characters.
Type of ship/cargo.
Dimensions of ship—to the nearest meter.
Location of positioning system's (e.g., GPS) antenna on board the vessel—in meters aft of bow and meters port of starboard.
Type of positioning system—such as GPS, DGPS or LORAN-C.
Draft of ship—0.1 meters to 25.5 meters.
Destination—max. 20 characters.
ETA (estimated time of arrival) at destination—UTC month/date hour: minute.
optional: high precision time request, a vessel can request other vessels provide a high precision UTC time and date stamp.

In addition to AIS data, proprietary data may also be included in certain embodiments.

In a conventional AIS installation most of data fields are updated automatically by querying ship's sensors. However, destination and draft data are often entered manually by the vessel crew. Data entry by hand is prone to errors, and it can be updated with a time delay from when the draft or destination changes. Since it is manually entered, it is not always updated until the vessel is finished loading or unloading cargo. For example, the ship's crew updates AIS data field “draft of ship” immediately after completion of cargo operations and while the ship is still at the berth, or often the ship's crew updates AIS draft data field (with a delay) while the ship is no longer at the berth and/or is no longer within the port limits.

A vessel's draft is indicative of its loading and a change in draft, except for minor variations, indicates a change in the vessel's loading status. Draft of a ship may change by 0.1 to 15 meters depending on the cargo. The table 1 below shows AIS draft data for a vessel.

TABLE 1

| RowNr | Timestamp | Draft value (meters) | |
|---|---|---|---|
| 01. | 05/01/2018 00:00 | 6.3 | m |
| 02. | 05/01/2018 01:00 | 6.3 | m |
| 03. | 05/01/2018 02:00 | 6.3 | m |
| 04. | 05/01/2018 03:00 | 6.3 | m |
| 06. | 05/01/2018 04:00 | 6.3 | m |
| 07. | 05/01/2018 06:00 | 10.3 | m |
| 08. | 05/01/2018 07:00 | 10.3 | m |
| 09. | 05/01/2018 08:00 | 10.3 | m |
| 10. | 05/01/2018 09:00 | 10.3 | m |
| . . . | | | |
| 40. | 05/03/2018 04:00 | 10.3 | m |
| 41. | 05/03/2018 05:00 | 7.5 | m |
| 42. | 05/03/2018 06:00 | 10.3 | m |
| 43. | 05/03/2018 07:00 | 10.3 | m |
| 44. | 05/03/2018 08:00 | 10.3 | m |

As per the above table, at rows 06-07, draft value changed from 6.3 to 10.3 meters which is by 4.00 meters. Here, a recording system may record a “Loading” operation with the Timestamp of 01/05/2018 06:00.

At rows 40, 41 and 42, draft value charged from 10.3 to 7.5 meters and then back to 10.3 m. In this case, row 41 may be considered as an outlier and omitted from any analysis, because the change of draft value happened during a very short timeframe (within 2 hours). Generally, such outliers can be related to errors in AIS data transmission and may be accordingly ignored.

### Average Draft Variation

The amount of draft change transmitted by AIS is generally a function of the great variety of vessels sizes. Merchant cargo vessel displacement varies from 10.000 deadweight tons (DWT) to 450.000 DWT and vessel length reaches 400 meters. This makes uniformity generalization subject to large errors.

However, the applicants, by analyzing a representative subset of global vessels fleet and its historical AIS Draft data, determined that draft value variance is proportional to the vessel size. The table below details observed draft minimums and maximums for different vessel sizes, as well as, observed draft standard deviation (STDEV), which is expressing by how much the draft value observations differ from the mean value.

TABLE 2

| | Observed min. | Observed max. | Observed standard |
|---|---|---|---|
| DWT | draft | draft | deviation |
| 400000 | 8 | 23.5 | 4.97 |
| 300000 | 8 | 23.5 | 4.30 |
| 200000 | 8 | 19 | 4.05 |
| 131000 | 7 | 16 | 1.94 |
| 51000 | 5 | 12.5 | 1.94 |
| 17000 | 4 | 8 | 0.77 |

The STDEV value per vessel may be used as the threshold for draft value change. Hence, to record a vessel operation, the draft value change would need to exceed the threshold determined by the STDEV. For example, a 400,000 DWT vessel draft has changed from 20.5 to 20.0 meters (0.5 meters). Since this amount is less than the 4.97 meters threshold for the vessel the draft change would not be recorded. This relatively insignificant draft value change of 0.5 meters may be a result of vessel de-ballasting or other reasons not related to vessel cargo operations. Whereas a draft change of 6 meters would indicate a change of cargo.

### Default Limit

In certain embodiments a threshold verification procedure may be employed to determine a default threshold limit. For example, and without limitation, other information sources, such as vessel's documents, log books, bills of lading, statements of facts, and the like. These documents may be employed to verify draft and cargo changes. These documents may detail the true events in relation to vessel cargo operations. During the verification process a determination may be made of whether the method is resulting in more or fewer vessel cargo operations being recorded than took place. Based on this verification, a default threshold limit may be determined, for example a limit of 1.5 meters may be used for larger vessels and a different limit may be employed for smaller vessels.

### Tonnes Per Centimeter Conversion

Additionally, it is possible to estimate the amount (metric tons) of cargo loaded or discharged. This can be accomplished by using the vessel characteristic Tonnes Per Centimeter Immersion (TPCI), which expresses the number of tonnes required to alter the draft of a vessel by one centimeter. The TPCI varies with the draft and with the water density. Changes in draft cause a change in displacement and the TPCI assists in calculating the change. TPCI can be calculated by the formula:

TPCI=(A)×(d)/100
where A=area of water plane at a certain draught and
d=density of water in which the ship floats.

Knowing the change in draft, provides for a calculation of the change in tonnage being carried by the vessel.

### Vessel Operations Location

In some embodiments, when a vessel cargo operation is recorded, a location may be assigned to the vessel cargo operation. The location may be a load/discharge station such as a port, terminal, off-shore transshipment zone, transfer zone, lightering zone, anchorage or other similar marine facility. Some embodiments may assign the nearest load/discharge station to the cargo operation based on the current vessel position. In alternative embodiments, the vessel's historical positions may be queried from a structured data store together with known load/discharge stations. These location databases may contain pre-defined geofences of these marine locations. Once queried, the valid load/discharge station may be recorded with the cargo operation information.

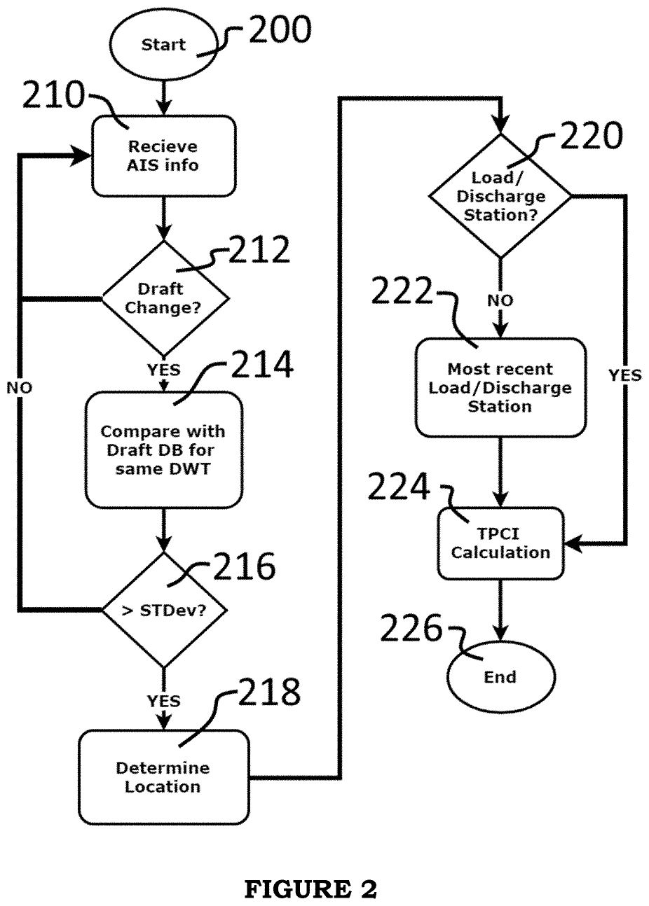

FIG. 2 illustrates steps in a method that may be employed in certain embodiments.

The method begins at a flow label 200.

At a step 210 a system, such as a processor or server, receives AIS information. This reception may be from a network such as the Internet.

At a step 212 the AIS is compared to historical data to determine if there is a change in a vessel's draft. If there is no appreciable change, then the method returns to the step 210. Otherwise the method proceeds to a step 214.

At the step 214 the standard deviation for the vessels weight class is queried from a data store.

At a step 216 the change in draft is compared to the standard deviation of draft changes from the step 214 (or a default limit, if employed). If the change in draft does not exceed the STDEV (or the default), then the method proceeds to the step 210. Otherwise the method proceeds to a step 218.

At the step 218 the vessel's location is determined.

At a step 220 a test is made to determine if the vessel in in a load/discharge station. If yes, the method proceeds to a step 224. Otherwise, the method proceeds to a step 222.

At the step 222 the most recently visited load/discharge station is associated with the change in draft operation.

At the step 224 a TPCI calculation may be performed in certain embodiments.

At a flow label 226 the method ends.

One having skill in the art will appreciate that not every step in the method of FIG. 2 needs to be performed to effectuate certain embodiments of the present disclosure. Moreover, the steps displayed do not need to be performed in the order presented.

The method disclosed herein may periodically interact with data sources and data stores for recording receiving, storing and reporting on the relevant information. These data sources and stores may be local to a server or remotely coupled to a system through a network such as the Internet.

### Embodiments of Applications

Knowing the vessel's load/discharge station may be indicative of a type of cargo, moreover, knowing the TCPI provides an indication of the amount of cargo. Moreover, a change in vessel draft is a better indicia of actual cargo movement than simply tracking a vessel from port to port because a change in draft shows actual cargo movement not just vessel movement. The table below represents cargo movement as may be determined from the present disclosure:

TABLE 3

| | | | |
|---|---|---|---|
| 01. | Jan. 1, 2018 | Discharging | Location: Port of Rotterdam, |
| | | | Terminal A |
| 02. | Jan. 5, 2018 | Loading | Location: Port of Rotterdam, |
| | | | Terminal B |
| 03. | Jan. 30, 2018 | Discharging | Location: Port of Houston TX, |
| | | | Terminal C |
| 04. | Feb. 15, 2018 | Loading | Location: Port of Baton Rouge, |
| | | | Terminal D |
| 05. | Mar. 2, 2018 | Discharging | Location: Port of Santos, |
| | | | Terminal E |
| 06. | Mar. 4, 2018 | Discharging | Location: Port of Santos, |
| | | | Terminal G |
| 07. | Mar. 6, 2018 | Loading | Location: Port of Santos, |
| | | | Terminal H |

The recorded data as shown in table 3 may be used as a component of a larger shipping management or smart vessel management application, for example, global cargo movement analysis, vessel performance benchmarks and the like.

In additional to berth and terminal information, additional information may be related to the type of cargo or type of vessel serviced at a particular port. For example, and without limitation, a user may identify two equally-capable ports located relatively close together, and direct cargo to the most efficient port. Or a user may schedule port calls with respect to operating efficiency for the type of vessel, so that perishable products are properly laded. In addition, reliable estimates on cargo movement may be effectuated independently of any direct cargo reporting by a vessel's crew or port authority, allowing for better management of cargo flows on a world-wide scale.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and, in a manner, consistent with the scope of the invention, as set forth in the following claims.

What is claimed:

1. A method including:
receiving at a server, a first AIS information indicative of a draft information for a vessel, said AIS information provided by a network;
querying a data source for statistical information associated with the vessel;
determining if a substantial change in vessel draft has occurred in response to the querying;
determining vessel location information from the first AIS information;
associating a load or discharge station with the first AIS information, and
recording the results of said associating.

2. The method of claim 1 further including:
receiving at the server a tonnes per centimeter immersion (TPCI), and
estimating a cargo amount in response to the TPCI and the draft information.

3. The method of claim 1 wherein said statistical information includes a standard deviation measure of historical vessel draft information.

4. The method of claim 1 wherein said load or discharge station is a pre-defined geofenced maritime area.

5. The method of claim 1 wherein said determining a substantial change in vessel draft includes comparing the draft information to a default limit value.

6. The method of claim 1 wherein said statistical information includes a standard deviation measure of historical vessel draft information and historical draft information.

7. A memory device including non-transitory, processor-readable instructions directing a processor to perform a method including the steps of:
receiving a first AIS information indicative of a draft information for a vessel;
querying a data source for statistical information associated with the vessel;
determining if a substantial change in vessel draft has occurred in response to the querying;
determining vessel location information from the first AIS information;
associating a load or discharge station with the first AIS information, and
recording the results of said associating.

8. The device of claim 7 wherein the method further includes:
receiving a tonnes per centimeter immersion (TPCI), and
estimating a cargo amount in response to the TPCI and the draft information.

9. The device of claim 7 wherein said statistical information includes a standard deviation measure of historical vessel draft information.

10. The device of claim 7 wherein said load or discharge station is a pre-defined geofenced maritime area.
